(19) United States
(12) Patent Application Publication
(10) Pub. No.: US 2021/0035183 A1
(43) Pub. Date: Feb. 4, 2021

(54) METHOD AND SYSTEM FOR A RECOMMENDATION ENGINE UTILIZING PROGRESSIVE LABELING AND USER CONTENT ENRICHMENT

(71) Applicant: Synchronoss Technologies, Inc., Bridgewater, NJ (US)

(72) Inventors: Casimir Saternos, Emmaus, PA (US); Alec Lazarescu, Fanwood, NJ (US)

(21) Appl. No.: 16/527,130

(22) Filed: Jul. 31, 2019

(51) Int. Cl. G06Q 30/06; G06N 20/20; G06Q 30/02

(52) U.S. Cl. CPC G06Q 30/0631; G06Q 30/0201; G06N 20/20

(57) ABSTRACT

A computer implemented method and system for a recommendation engine utilizing progressive labeling and user context enrichment. The method comprises receive a request from a current user of a user device, for a recommendation of an item, wherein the request comprises an image of the item; analyzing the item in the image using a plurality of objective machine learning models, wherein analyzing the item in the image comprises assigning an objective label and a percentage of confidence in the assigned label for each of the objective machine learning models; analyzing the item in the image using a plurality of subjective machine learning models wherein analyzing the item in the image comprises assigning an subjective label and a percentage of confidence in the assigned label for each of the subjective machine learning models; retrieving user context information for the current user; generating a plurality of new labels based on the objecting labels, subjective labels, and user context information, wherein each of the plurality of new labels includes a weight signifying the importance of each new label; retrieve one or more recommendations, wherein the one or more recommendations comprise universal resource locations to clothing that matches the labels assigned to the image; and transmit the one or more recommendations to the user device when a confidence level in the recommendations exceeds a predefined threshold.

### BACKGROUND OF THE INVENTION

### Field of the Invention

Embodiments of the present invention generally relate to digital shopping assistants, and more specifically to a recommendation engine utilizing progressive labeling.

### Description of the Related Art

Today, consumers can shop online for nearly any product. Digital shoppers go online to purchase items such as groceries and household consumables every day. However, when it comes to purchasing other items, such as clothing, accessories, interior design, vacation location, rental property, art, and more, the online consumer has more complex challenges in finding what he or she is looking for. Digital shopping assistants can be helpful to consumers in selecting what to purchase. However, consumers may have a difficult time articulating exactly what they are looking for, while a photo would provide more information in steering the virtual assistant in the right direction.

Typically, digital shopping assistants use monolithic neural networks in isolation to make a decision about what a consumer is looking for. However, with the monolithic approach, it is difficult to determine why and enhance how decisions are made. In addition, digital shopping assistants do not typically provide a natural language or a visual input interactive experience for the online consumer. This results in a poor user experience.

Therefore, there is a need for a recommendation engine utilizing progressive labeling and user context enrichment.

### SUMMARY OF THE INVENTION

A system and/or method is provided for a recommendation engine utilizing progressive labeling and user context enrichment substantially as shown in and/or described in connection with at least one of the figures.

These and other features and advantages of the present disclosure may be appreciated from a review of the following detailed description of the present disclosure, along with the accompanying figures in which like reference numerals refer to like parts throughout.

### BRIEF DESCRIPTION OF THE DRAWINGS

FIG. 1 depicts a block diagram of a system for a recommendation engine utilizing progressive labeling and user context enrichment, according to one or more embodiments of the invention;

FIG. 2 depicts a flow diagram of a method for providing a recommendation to a consumer utilizing progressive labeling and user context enrichment based on an uploaded image, according to one or more embodiments of the invention;

FIG. 3 depicts a flow diagram of a method for increasing a confidence level for a recommendation, according to one or more embodiments of the invention;

FIG. 4 depicts a flow diagram of a method for providing recommendations to a user based on a user text, according to one or more embodiments of the invention;

FIG. 5 depicts a flow diagram of a method for providing a system-initiated recommendation to a user, according to one or more embodiments of the invention; and

FIG. 6 depicts a computer system that can be utilized in various embodiments of the present invention to implement the computer and/or the display, according to one or more embodiments of the invention.

While the method and system is described herein by way of example for several embodiments and illustrative drawings, those skilled in the art will recognize that the method and system for a recommendation engine utilizing progressive labeling and user context enrichment is not limited to the embodiments or drawings described. It should be understood, that the drawings and detailed description thereto are not intended to limit embodiments to the particular form disclosed. Rather, the intention is to cover all modifications, equivalents and alternatives falling within the spirit and scope of the method and system for a recommendation engine utilizing progressive labeling and user context enrichment defined by the appended claims. Any headings used herein are for organizational purposes only and are not meant to limit the scope of the description or the claims. As used herein, the word “may” is used in a permissive sense (i.e., meaning having the potential to), rather than the mandatory sense (i.e., meaning must). Similarly, the words “include”, “including”, and “includes” mean including, but not limited to.

### DETAILED DESCRIPTION OF EMBODIMENTS

Techniques are disclosed for a system and method for a recommendation engine utilizing progressive labeling and user context enrichment, according to embodiments of the invention. A user uploads an image that includes an item in which they are interested. The recommendation engine returns recommendations of items that match the item in the image. The image may be of a clothing item, a piece of jewelry, a vacation home, a piece of artwork, or any item of interest. The image is validated to ensure the image is valid. For example, if a user uploads a picture of their cat, the image is determined to be invalid because it does not include an item that may be purchased through the recommendation engine. Although the present description uses an item of clothing as an example, those skilled in the art will understand the present invention may be used to make a recommendation on any item.

Some pre-processing may be performed on the image, such as removing the background, removing faces, enhancing the image, and the like. The image is then routed through a plurality of objective machine learning models to determine objective elements of the item. Objective machine learning models analyze a clothing item in concrete and most likely, non-changing terms. For example, the image of a clothing item may be routed to a clothing type model, a color scheme model, a pattern model, a material model, and the like. An image of a piece of jewelry may be routed through a jewelry type model, a color scheme model, a pattern model, a material model, and the like. Machine learning models exist for any valid item submitted to the recommendation engine. Each model assigns one or more labels to the image as well as a percentage that the label is likely to be correct. Output from one model may be used as input to the next model. Upon exiting the objective models, the image of an item of clothing may include labels for example, “blue”, “solid”, “cotton”, “hoodie”. The image with the assigned labels is then routed through a plurality of subjective machine learning models to further classify the image. Subjective machine learning models analyze the clothing item in terms that change over time. Subjective models may include a season model, an age category model, a brand/logo model, a celebrity model, a style model, and the like. Upon output from the subjective models, the image of the item of clothing may also have been assigned the additional labels of “autumn”, “teen”, and “hip-hop”.

A user context service is accessed to retrieve additional information about the user. The user context service may return information regarding the age or income level of the user, purchase history, data about cohorts of the user that may have similar tastes as the user, influencer input as to the style preferred by the user, and the like. The list of labels and the user information are aggregated by an aggregate recommendation model and a new set of labels is generated with weights signifying the relative importance of each label. The new set of labels and associated weights are used by a recommendation processor to request images from an image service. If the confidence level that the returned images is above a predefined threshold, one or more images of items may be returned to the consumer for feedback or for purchase. If the confidence level of the return images is below the predefined threshold, additional processing is performed until the confidence level is high enough to share the recommendations with the user.

Various embodiments of a method and system for a recommendation engine utilizing progressive labeling and user context enrichment are described. In the following detailed description, numerous specific details are set forth to provide a thorough understanding of claimed subject matter. However, it will be understood by those skilled in the art that claimed subject matter may be practiced without these specific details. In other instances, methods, apparatuses or systems that would be known by one of ordinary skill have not been described in detail so as not to obscure claimed subject matter.

Some portions of the detailed description that follow are presented in terms of algorithms or symbolic representations of operations on binary digital signals stored within a memory of a specific apparatus or special purpose computing device or platform. In the context of this particular specification, the term specific apparatus or the like includes a general-purpose computer once it is programmed to perform particular functions pursuant to instructions from program software. Algorithmic descriptions or symbolic representations are examples of techniques used by those of ordinary skill in the signal processing or related arts to convey the substance of their work to others skilled in the art. An algorithm is here, and is generally, considered to be a self-consistent sequence of operations or similar signal processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals or the like. It should be understood, however, that all of these or similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining” or the like refer to actions or processes of a specific apparatus, such as a special purpose computer or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device. One skilled in the art will appreciate that any of the present invention may be implemented on specific or general purpose computers (e.g., cloud servers) that communicate with devices and/or the devices themselves leveraging edge computing provided sufficient resource and capabilities are available.

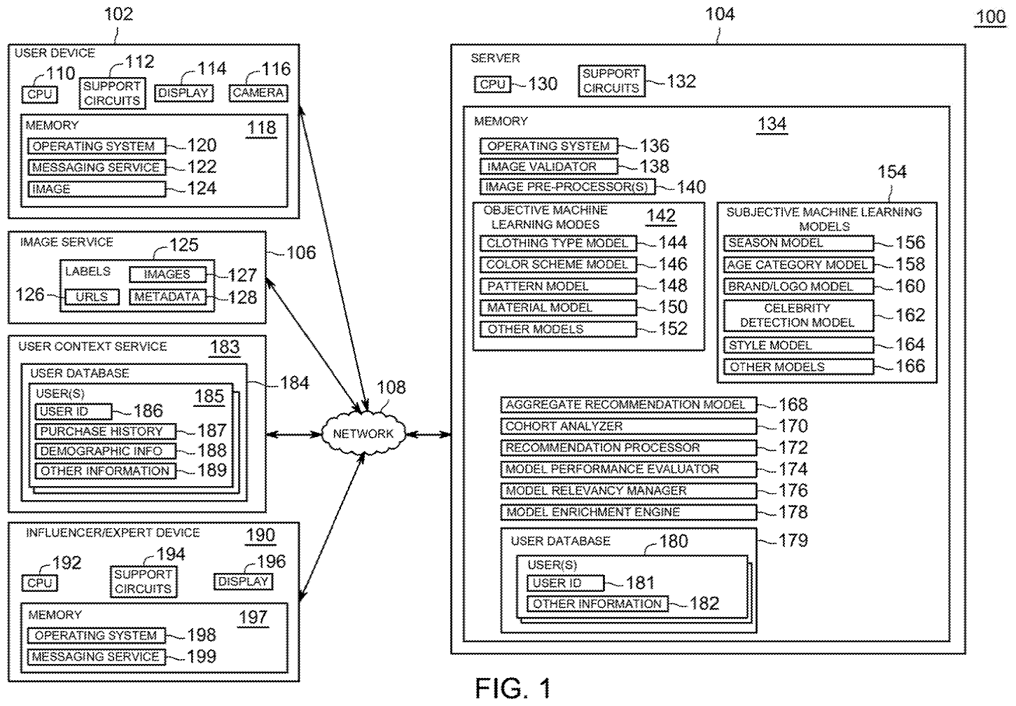

FIG. 1 depicts a block diagram of a system 100 for a recommendation engine utilizing progressive labeling and user context enrichment, according to one or more embodiments of the invention. The system 100 includes a user device 102, a server 104, an image service 106, a user context service 183, and a style influencer (or expert) device 190, communicatively coupled via network 108. The user device 102 is a computing device, such as a desktop computer, laptop, tablet computer, Smartphone, smartwatch or other wearable, smart speaker with a screen, and the like. The user device 102 includes a Central Processing Unit (CPU) 110, support circuits 112, a display 114, a camera 116, and a memory 118. The CPU 110 may include one or more commercially available microprocessors or microcontrollers that facilitate data processing and storage. The various support circuits 112 facilitate the operation of the CPU 110 and include one or more clock circuits, power supplies, cache, input/output circuits, and the like. The memory 118 includes at least one of Read Only Memory (ROM), Random Access Memory (RAM), disk drive storage, optical storage, removable storage and/or the like. The memory 118 includes an operating system 120, a messaging service 122, and an image 124. The operating system 120 may include various commercially known operating systems. In some embodiments, the messaging service 122 is a native messaging app on the user device 102. In some embodiments, the messaging service 122 is a mobile application downloaded to the user device 102 from an app store (not shown). In some embodiments, the messaging service 122 is provided within a separate app, such as Facebook® Messenger. In some embodiments, the messaging service 122 is provided through a browser or other software integrated with the camera 116 or other camera application.

The server 104 may be in the cloud. Examples of the server 104 include, but are not limited to a blade server, virtual machine, and the like. Additional examples of the server 104 include, but are not limited to desktop computers, laptops, tablet computers, Smartphones, and the like. The server 104 includes a Central Processing Unit (CPU) 130, support circuits 132, and a memory 134. The CPU 130 may include one or more commercially available microprocessors or microcontrollers that facilitate data processing and storage. The various support circuits 132 facilitate the operation of the CPU 130 and include one or more clock circuits, power supplies, cache, input/output circuits, and the like. The memory 134 includes at least one of Read Only Memory (ROM), Random Access Memory (RAM), disk drive storage, optical storage, removable storage and/or the like. The memory 134 includes an operating system 136. The operating system 136 may include various commercially known operating systems. The memory 134 also includes an image validator 138, various pre-processors 140, a plurality of objective machine learning models 142, a plurality of subjective machine learning models 154, an aggregate recommendation model 168, a cohort analyzer 170, a recommendation processor 172, model performance evaluator 174, a model relevancy manager 176, a model enrichment engine 178, and a user database 179.

The various pre-processors 140 are of different types and may be used as various stages throughout the system. For example, one or more pre-processors may determine whether an image is valid. Other pre-processors 140 may include image filters for example, to remove a background and/or faces in the image 124, to extract clothes or other relevant features in the image 124, to enhance the image 124, to normalize the image 124 (e.g., resize, convert to greyscale, remove blur), and the like. The image filters may be a combination of both traditional and machine learning algorithms. In some embodiments, the objective machine learning models 142 and the subjective machine learning models 154 are convolutional neural networks that analyze images. The objective machine learning models 142 may include a clothing type model 144, a color scheme model 146, a pattern model 148, a material model 150, and various other objective models 152. The various other objective models 152 may be objective models 142 used to labeling items other than clothing. For example, when the recommendation engine receives an image of a vacation home, an objective model 152 may be a location model that labels the image with “beach” or “mountains”. The subjective machine learning models 154 include a season model 156, an age category model 158, a brand/logo model 160, a celebrity detection model 162, a style model 164 and various other subjective models 166. In some embodiments, the various pre-processors 140 may be used to alter an image based on a machine learning model, such that the image may be analyzed by one or more machine learning models. The user database 179 includes a plurality of users 180, wherein each user 180 includes a user identifier (user ID) 181 and other information 182. These user ID 181 links to the user ID 186 in the user database 184 of the user context service 183. Although the machine learning models 142 and 154 are shown as part of server 104, the objective machine learning models 142 and/or the subjective machine learning models 154 may be located on one or more servers remote from server 104. In some embodiments, some or all machine learning models 142 and 154 are owned by third parties and accessed via Application Programming Interfaces (APIs). In some embodiments, the pre-processors 140 and one or more machine learning models 142, 154 may be implemented on an application on the user device 102 provided the application has sufficient resources and capabilities to run on the user device 102.

The user context service 183 stores and retrieves information about a user 185. The user database 184 stores information about a plurality of users 185, searchable by their user ID 186. For each user 185, the user context service 183 stores a purchase history 187, demographic information 188 (e.g., location, age, etc.), and other information such as preferences that are determined from specifically answered question from the user 185 via clarification prompts, previously liked/click/purchased goods, influencer provided recommendations for the user 185, inferred preferences or behaviors based on cohorts belonging to, for example, a same geographical region and/or income bracket, and the like. Additionally, any purchase or like signaling from the user would be tracked and boost relevance of any recommendation inputs generating that recommendation. For example, if both a cohort user's matched item and a label of Gigi Hadid were part of the clicked/liked/purchased recommendation, those traits would serve as reinforcement leading to a boost in relevance for the future.

The image service 106 includes a plurality of labels 125, wherein each label 125 includes one or more Universal Resource Locators (URLs) 126 that lead to images, where each URL links to an item that matches one or more labels 125 for the image 124. The image service 106 may include a plurality of images 127, in addition to the URLs 126, and includes metadata 128 that includes labels, vendors, available sizes, and the like. In some embodiments, the image service 106 is implemented as a SOLR index. In some embodiments, the image service 106 is implements as an Elasticsearch index. Those skilled in the art will appreciate that any technology capable of mapping an image to associated labels and supports weighted criteria searches may be used. The network 108 includes a communication system that connects computers (or devices) by wire, cable, fiber optic and/or wireless link facilitated by various types of well-known network elements, such as hubs, switches, routers, and the like. The network 108 may be a part of the Intranet using various communications infrastructure, such as Ethernet, Wi-Fi, a personal area network (PAN), a wireless PAN, Bluetooth, Near field communication, and the like.

The influencer/expert device(s) 190 is a computing device, such as a desktop computer, laptop, tablet computer, Smartphone, smartwatch or other wearable, and the like. The influencer/expert device 190 is an input channel which may be a physical computer or phone with a messaging service. The influencer/expert device 190 includes a Central Processing Unit (CPU) 192, support circuits 194, a display 196, and a memory 197. The CPU 192 may include one or more commercially available microprocessors or microcontrollers that facilitate data processing and storage. The various support circuits 194 facilitate the operation of the CPU 192 and include one or more clock circuits, power supplies, cache, input/output circuits, and the like. The memory 197 includes at least one of Read Only Memory (ROM), Random Access Memory (RAM), disk drive storage, optical storage, removable storage and/or the like. The memory 197 includes an operating system 198, and a messaging service 199. The operating system 198 may include various commercially known operating systems. Alternatively, the influencer/expert device(s) 190 may be reached indirectly, for example using an Amazon Mechanical Turk® (MTurk) style question and answer fulfillment system wherein a web interface (desktop or mobile) collects influencer input and uses a messaging interface in the cloud to communicate the results back to the server 104.

A user of user device 102 may find a photo of, for example an article of clothing online or use camera 116 to take a photo of someone wearing an article of clothing that is of interest to the user. The user uploads the photo as image 124 using messaging service 122. Messaging service 122 transmits the image 124 to the server 104, where the image validator 138 determines whether the image 124 is valid. For example, the image 124 is valid if the image 124 includes an article of clothing, but invalid if the image 124 is of a bird. If the image 124 is invalid, a message is transmitted to the user via the messaging service 122 stating that image 124 cannot be processed. In some embodiments, the image 124 is validated on the user device 102 to prevent transmission of the image 124 if processing on the server 104 is unnecessary. However, if the image 124 is valid, it is then determined whether the image 124 requires pre-processing. The image 124 may need to be normalized if the size of the image 124 is too large and requires scaling. The image 124 may need to be pre-processed depending on which machine learning models are used. For example, a machine learning model may require specific input, such as a black and white image. The image 124 may need to be blurred or sharpened before it can be analyzed by a machine learning model. Bounding box identification and/or cropping may be required by one or more machine learning models. Some machine learning models may send the image 124 back to be pre-processed before re-attempting analysis of the image 124; if for example, the model certainty of the analysis is below a configurable threshold. If the image 124 requires pre-processing, pre-processors 140 filter the image as needed such that it can then be analyzed by the machine learning models. Objective machine learning models 142 offer analysis of a more factual and impartial nature. For example, the color blue is always blue. Subjective models 154 may vary over time and change with the emergence of new categories. For example, the age category for a style of dress is subjective as it may change over time. Machine learning models 142 and 154 may be re-trained in a manner and frequency in alignment with the nature of the features set labels within their domain.

Whether the image 124 is pre-processed, or the raw image 124 is used, the image 124 is then processed through a plurality of objective machine learning models 142. If the image 124 is valid, but the item of interest is unclear, a prompt may be sent to the user to clarify what item in the image 124 is of interest. For example, if the image 124 is of a woman wearing a bathing suit and sunglasses, the user may be prompted whether they are interested in the bathing suit, the sunglasses, or both. Each machine learning model 142 analyzes the image 124 and assigns a label and an associated probability of correctness of said label to the item of clothing in the image 124. For example, the clothing type model 144 may assign a label of “hoodie” with a 90% probability of correctness to the image 124. The color scheme model 146 may assign a label of “blue” with a 100% probability of correctness to the image 124. The image 124 is similarly analyzed through the pattern model 148 to determine for example a solid, the material model 150 to determine for example cotton, and any of the various other objective machine learning models 152. The image is then processed through a plurality of subjective machine learning models 154. For example, the season model 156 may assign a label of “spring” with an 80% probability of correctness to the image 124. The age category model 158 may assign a label of “18-24” with a probability of 95% to the image 124. The brand/logo model 160 may recognize a D&G® on the clothing and assign a label of “Dolce & Gabbana” with a 100% probability of correctness to the image 124. The celebrity detection model 162 may recognize that the person in the image 124 is Gigi Hadid wearing the clothing and assign “Gigi Hadid” with a 100% probability of correctness to the image 124. The image 124 may be processed through a style model 164, where the image 124 may be assigned a label for example, “casual” or “hip-hop” or “techie”, and the like, to provide a classification of the overall style of the item. The image 124 may be similarly analyzed through various other subjective machine learning models 166. After processing by the objective machine learning models 142 and the subjective machine learning models 154, the image 124 includes a plurality of labels and a percentage of correctness for each label.

The aggregate recommendation model 168 takes as input, the labels from the objective models 142 and the subjective models 154 in addition to information retrieved from the user context service 183. As output, the aggregate recommendation model 168 generates a new set of labels with a weight assigned to each label. The weights signify the relative importance of each label.

The recommendation processor 172 uses the labels with weights as input to the image service 106, which in turn returns a set of URLs and metadata associated with those URLs, such as bounding boxes, vendor, price, available sizes, and the like. The user context service accesses the user database 179 to retrieve information about the user and his or her clicking/buying history as well as other potential data such as answered questions, influencer provided recommendations, and the like. Based on the labels and other data retrieved, the recommendation processor 172 determines whether there is enough confidence in the proposed recommendation to send one or more URLs directly to the user via the messaging service 122. The confidence level is based on the selected models in use as well as user specific information retrieved from the user context service 831. A global level of confidence is determined through initial testing/baselining of the system. Essentially, if “bad” responses are being given, the level of confidence is dropped. The level of confidence is based also on the particular set of objective and subjective machine learning models in use. Objective models are inherently easier to interpret and contribute to a higher level of confidence. Certain subjective models provide relatively uncertain results and will result in a smaller possible increase to the global confidence level. The global level of confidence is applicable as-is when no further data on the specific user is available. However, the level of confidence applied is adjusted based on user specific information when available. For instance, we can be more confident in a recommendation for a user who has accepted all previous recommendations (resulting in purchases) than a user who has rejected numerous previous recommendations.

If the recommendation processor 172 determines that there is not enough confidence in the proposed recommendation, the cohort analyzer 170 determines if a different user in the user database 179 shares a similar buying history with the current user. For example, the cohort analyzer 170 may find a different user within the same age range category as the current user or with other similar demographic information, who purchases clothing worn by Gigi Hadid, and who has purchased a D&G hoodie in the recent past. This information may be used to make a recommendation that can be applied to the current user. As such, the confidence level may increase enough based on the results of the cohort analyzer 170 that a recommendation can be sent back to the user via the messaging service 122.

If the confidence level of a recommendation is still not high enough after analysis by the cohort analyzer 170, the model enrichment engine 178 determines that a clarification question may need to be sent to a human style influencer 190. The model enrichment engine 178 formulates and transmits the question to the style influencer 190 based on user information retrieved from the user database 179 and the assigned list of labels associated with the image 124. The style influencer 190 returns a response to the questions. If the model enrichment engine 178 determines that the response can be used to raise the confidence level of a recommendation choice, directly, or indirectly provides other input on style that pushed the confidence level above the predefined threshold, the recommendation processor 172 sends the recommendation to the user via messaging service 122. However, if the confidence level is still not high enough to make a recommendation, the model enrichment engine 178 may perform automated retraining and/or tuning model adjustments with the intention of raising the confidence level. Provided these operations can complete quickly (i.e. below a specified threshold representing the user tolerance for delayed responses) the model is re-run. Confidence is then checked to determine if the flow to the recommendation processor 172 can continue. If not, a fallback could result in an interactive user dialog through the message service 122 that makes the uncertainty expectation clear. For example, “I think you might like X, but I'm not sure. Do you like this? Should I keep searching?”. This approach incorporates user feedback on the “best guess” and ensures the user can choose whether further attempts with uncertain confidence should occur or the system should stop.

After the recommendations are sent to the user, the behavior of the user is monitored and recorded. User behavior may include click-through rate, a conversion rate of presented recommendations, sentiment analysis, engagement time and level with the system. Any type of user behavior is stored through the user context service 183 into a user database 179. In addition, the model performance evaluator 174 evaluates the user behavior and tracks historical performance of a model, including but not limited to confidence thresholds reached and user behaviors. With the model performance evaluator 174 and other automated quality checks as input, the model relevancy manager 176 determines whether an automatic model adjustment is required (i.e., retrained with new data). In some embodiments, the relevancy check may be initiated based on a preset schedule. However, an alarm based on low confidence thresholds and/or quality trends may trigger automatic retraining of one or more models or be flagged for machine learning engineer/data scientist review. The model enrichment engine 178 requests data from users or influencers for use in retraining the models. As such, the machine learning models are constantly being retrained in order to improve the selection of recommendations for the user.

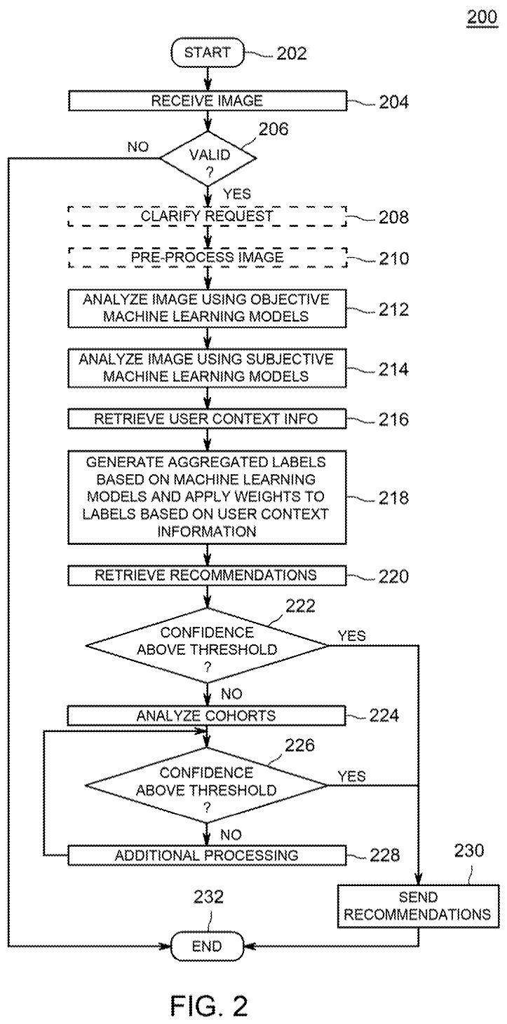

FIG. 2 depicts a flow diagram of a method 200 for providing a recommendation to a consumer utilizing progressive labeling and user context enrichment, according to one or more embodiments of the invention. The method 200 starts at step 202 and proceeds to step 204.

At step 204, an image is received. The image is from a user device. The user of the user device may have a vague idea for an item to purchase and desires additional guidance to assist in their decision making. Additional information can be used to provide more targeted recommendations via labels associated with the user or with the user's previous purchases.

At step 206, it is determined whether the received image is valid. A valid image includes at least one piece of clothing. For example, an image that includes a person in a sweater and jeans next to a fireplace is valid, where an image of a cat is invalid. If at step 206, it is determined that the image is invalid, then the method 200 proceeds to step 224 where a message is sent to the user indicating that the image cannot be processed and the method ends at step 230. However, if at step 206, it is determined that the image is valid, the method 200 optionally proceeds to step 208.

Optionally, at step 208, a message is sent to the user to clarify the user request. In the present example, the user may be asked if they wish to receive recommendations of items similar to the sweater or similar to the jeans, or both.

Optionally, at step 210, the image is pre-processed. The image may require pre-processing before it is analyzed by the machine learning models. For example, the image may be filtered to remove the background or one or more faces. The image may be filtered to extract clothes or other relevant features in the image. The image may be enhanced or normalized to define features of the image, resize the image, and the like.

At step 212, the image is analyzed by a plurality of objective machine learning models. Objective models determine basic facts regarding the clothing such as the type of clothing (e.g., outerwear, hoodie, sweatshirt), the material with which the clothing is made (e.g., cotton, wool), the color of the clothing (e.g., dark, black, midnight black), the pattern of the clothing (e.g., solid, plaid, striped) and the like. Each model assigns a label to the image based on the analysis. Each model also assigns a percentage of confidence in the correctness of the label. For example, after being analyzed by each of the above-mentioned models, the image may have labels and their confidence of “bikini” 100%, “lycra” 90%, “mauve” 80%, “polka dot” 100%.

At step 214, the image is analyzed by a plurality of subjective machine learning models. Subjective models determine classifications of the clothing in the image, where classifications change over time due to, for example the latest trends and celebrity endorsements. Each model assigns a label to the image based on the analysis. Each model also assigns a percentage of confidence in the correctness of the label. For example, after being analyzed by each of the subjective machine learning models, the image may have the additional labels and their confidence of “beachwear” 100%, “teenager” 90%, “summer” 80%, “cruise” 60%, “art-infused” 80%.

At step 216, user context information is retrieved from a user context service. The user context service may return a purchase history, demographic information, and other information such as preferences that are determined from previously answered question from the user, previously liked/click/purchased goods, influencer provided recommendations for the user, explicitly provided or inferred preferences, or behaviors based on cohorts belonging to, for example, a same geographical region and/or income bracket, and the like.

At step 218, the labels that were output from the machine learning models are analyzed in combination with the user context information to generate new labels. The labels and confidence values are translated by the model into a new set of labels with weights signifying the relative importance of each label rather than a confidence. The confidence input could lead certain labels to be dropped altogether from the output while others to be boosted higher in weight given extra certainty.

At step 220, one or more recommendations are retrieved for the user based on the new weighted labels. The list of labels is sent to an image service that in turn returns the Universal Resource Locator (URL) links to images that have metadata matching the newly generated labels.

At step 222, it is determined whether the confidence in the retrieved recommendations exceeds a predefined threshold. The system only sends recommendations to the user when a confidence level of the recommendation is sufficiently high that the recommendations are likely to match what the user is looking for. If the confidence level is above the predefined threshold, the method proceeds to step 230, where the recommendations are sent to the user, at which time the method proceeds to step 232 and ends. However, if it is determined that the confidence in the retrieved recommendations does not meet the predefined threshold, then the method proceeds to step 224.

At step 224, cohorts are analyzed. Cohorts are other users who are of the same age group, for example, or one of other relatable values that may include a similar demographic information, similar preferences that are determined from previously answered question from the user, similar influencer provided recommendations for the user, explicitly provided or inferred preferences, and the like. An even stronger signal would be or have purchasing preferences and histories that are similar to the current user. More specifically, cohorts may have previously purchased the same shirts and shoes as the current user. A cohort with a similar purchasing history may also be a purchaser of items worn by a celebrity that matching the celebrity in the image that was uploaded by the user. Given the similarities in the purchasing preferences, histories, and celebrity trendsetters, a cohort's style may be similar to the style of clothes that the current user likes. It is possible that an item purchased by a cohort may match an item retrieved by the image service. The cohort analysis may narrow the recommendations and/or increase the confidence level in one or more recommendations.

At step 226, it is again determined whether the confidence in the recommendations exceeds a predefined threshold. If the confidence level is above the predefined threshold, the method proceeds to step 230, where the recommendations are sent to the user, at which time the method proceeds to step 232 and ends. However, if it is determined that the confidence in the retrieved recommendations does not meet the predefined threshold, then the method proceeds to step 228.

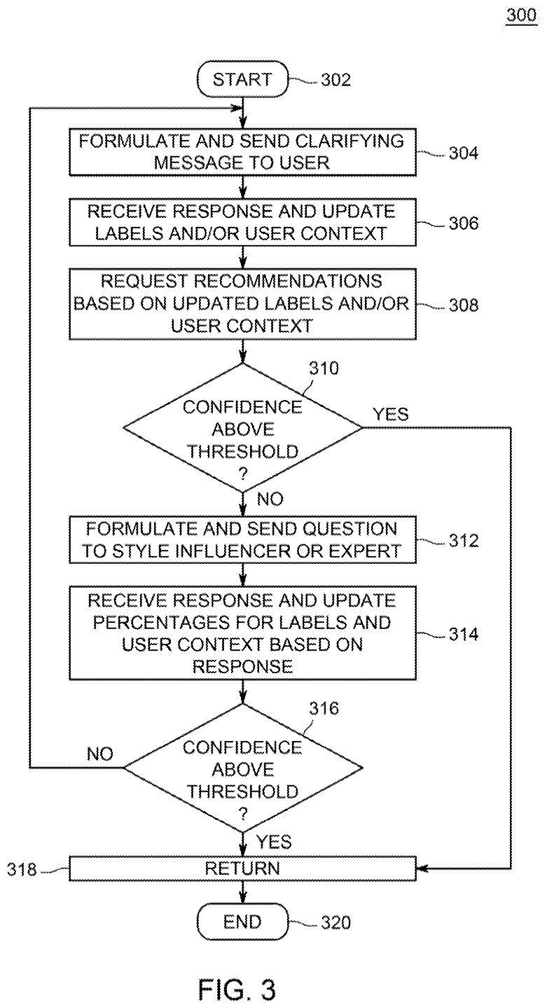

At step 228, the recommendations are subjected to additional processing. In some embodiments, questions are formulated for style advisors who may step in and assist with the recommendations selection or confidence level, as described in further detail with respect to FIG. 3 below. The method proceeds to step 226 and iterates until the confidence exceeds a predefined threshold at which time the method 200 proceeds to step 230 where the recommendations are sent to the user. The method ends at step 232.

FIG. 3 depicts a method 300 for increasing a confidence level for a recommendation, according to embodiments of the invention. The method 300 uses interaction with the user or others to clarify what may be recommended to the user. The method 300 starts at step 302 and proceeds to step 304.

At step 304, a message is formulated and sent to the user to clarify what the user is looking for. For example, the question may be “That's a good looking black hoodie you have selected. Are you interested in seeing hoodies in other colors as well?” or “Here is another black hoodie. Do you like it?” or “I could not find any black hoodies in stock. What do you think of a black sweatshirt?” The questions assist with choosing what to recommend to the user.

At step 306, the user response is received, and the labels associated with the image and/or the user context are updated.

At step 308 one or more recommendations are retrieved for the user based on the updated label assigned to the image or the user context. The updated list of labels is sent to an image service that returns the Universal Resource Locator (URL) links to images that have labels matching the labels determined by the plurality of objective and subjective machine learning models.

At step 310, it is determined whether the confidence in the retrieved recommendations exceeds a predefined threshold. If the confidence level is above the predefined threshold, the method proceeds to step 318, where the method returns to method 200. However, if it is determined that the confidence in the retrieved recommendations does not meet the predefined threshold, then the method proceeds to step 312.

At step 312, it is determined that human intervention may be required. A question is formulated and sent to a style influencer or other style expert. The question may request information that may be used to determine recommendations to users. For example, a question may be “Which of these styles is trending now?” or “Fashion emergency! We need your advice. Which of these outfits is really on point?” or “Ready for that power lunch? Which of these will help you own the room?”

At step 314, the response is received and the labels, percentages, or user context are updated. At step 316, it is determined whether one or more of the received images now has a confidence level above the predefined threshold. If none of the recommendations has a confidence level above the predefined threshold, the method proceeds to step 304 and iterates until at one or more recommendations has a confidence level that exceeds the predefined threshold at which time the method proceeds to step 318 and returns to method 200. The method 300 ends at step 320.

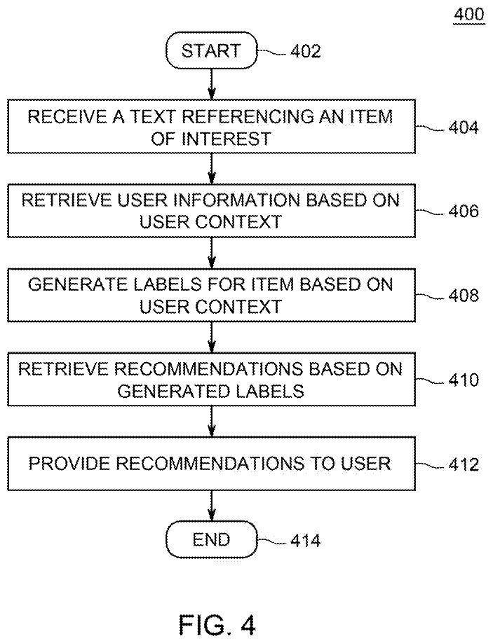

FIG. 4 depicts a flow diagram of a method 400 for providing recommendations to a user based on a user text, according to one or more embodiments of the invention. The method 400 starts at step 402 and proceeds to step 404.

At step 404, the recommendation engine receives a text from a user device referencing an item of interest. For example, the text may read, “sweater”.

At step 406, user context information is retrieved from a user context service to gain insight into what the user may like with regard to “sweater”. For example, the purchase history may show that the user has purchased items with a Gucci label, or user context information may indicate that the user likes dark colored clothing.

At step 408, the user context information is used to generate labels for the item. The labels in the present example may be “Gucci”, “black”, “navy”, and the like. As such the user context information narrows what will be returned as recommendations based on the user context information of the user.

At step 410, recommendations are retrieved based on the labels generated based on user context.

At step 412, the recommendations are sent to the user. The method 400 ends at step 414.

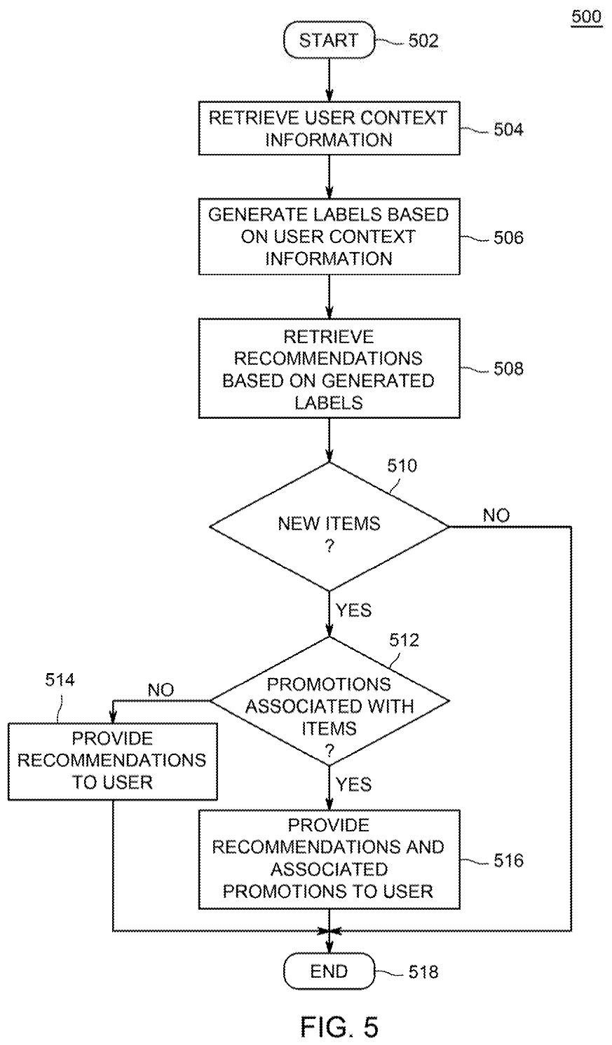

FIG. 5 depicts a flow diagram of a method 500 for a providing a system-initiated recommendation to a user, according to one or more embodiments of the invention. The method 500 starts at step 502 and proceeds to step 504.

At step 504, user context information is retrieved from the user context service. Again, the user context information provides insight into what the user may like.

At step 506, a plurality of labels is generated based on the user context information.

At step 508, recommendations are retrieved based on the generated labels. The retrieved recommendations are based solely on the user context information. As such, there is a high confidence that the recommendations are appropriate for the user.

At step 510, it is determined whether any of the recommendations that are retrieved are new, in that they have not been previously presented to the user. If there are no new recommendations for the user, the method 500 proceeds to step 518 and ends.

However, if at step 510, it is determined that there are new recommendations to send to the user, then at step 512, it is determined whether any promotions are associated with one or more of the recommendations. For example, an item may be on sale or a coupon may be available for one or more of the recommended items.

If at step 512, there are no promotions available, then at step 514, the recommendations are sent to the user and the method 500 ends at step 518.

However, if at step 512, it is determined that promotions exist for one or more of the recommendations, then at step 516, the recommendations and associated promotions are sent to the user and the method ends at step 518.

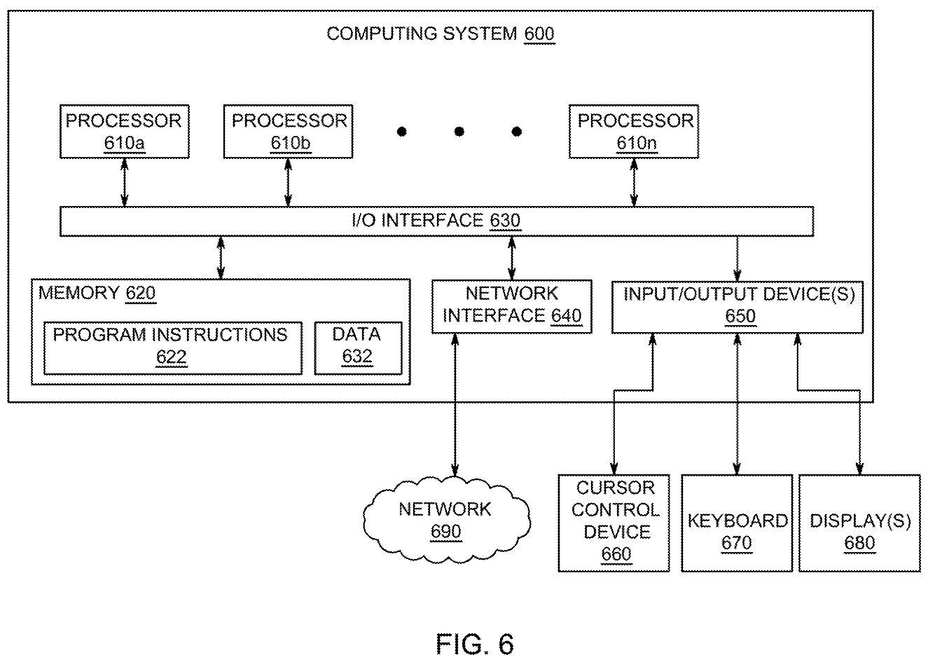

FIG. 6 depicts a computer system that can be used to implement the methods of FIG. 2, FIG. 3, FIG. 4, and FIG. 5 in various embodiments of the present invention.

Various embodiments of method and system for a recommendation engine utilizing progressive labeling and user context enrichment, as described herein, may be executed on one or more computer systems, which may interact with various other devices. One such computer system is computer system 600 illustrated by FIG. 6, which may in various embodiments implement any of the elements or functionality illustrated in FIGS. 1-5. In various embodiments, computer system 600 may be configured to implement methods described above. The computer system 600 may be used to implement any other system, device, element, functionality or method of the above-described embodiments. In the illustrated embodiments, computer system 600 may be configured to implement methods 200 through 500, as processor-executable executable program instructions 622 (e.g., program instructions executable by processor(s) 610) in various embodiments.

In the illustrated embodiment, computer system 600 includes one or more processors 610 coupled to a system memory 620 via an input/output (I/O) interface 630. Computer system 600 further includes a network interface 640 coupled to I/O interface 630, and one or more input/output devices 650, such as cursor control device 660, keyboard 670, and display(s) 680. In various embodiments, any of components may be utilized by the system to receive user input described above. In various embodiments, a user interface (e.g., user interface) may be generated and displayed on display 680. In some cases, it is contemplated that embodiments may be implemented using a single instance of computer system 600, while in other embodiments multiple such systems, or multiple nodes making up computer system 600, may be configured to host different portions or instances of various embodiments. For example, in one embodiment some elements may be implemented via one or more nodes of computer system 600 that are distinct from those nodes implementing other elements. In another example, multiple nodes may implement computer system 600 in a distributed manner.

In different embodiments, computer system 600 may be any of various types of devices, including, but not limited to, a personal computer system, desktop computer, laptop, notebook, or netbook computer, mainframe computer system, handheld computer, workstation, network computer, a camera, a set top box, a mobile device, a consumer device, video game console, handheld video game device, application server, storage device, a peripheral device such as a switch, modem, router, or in general any type of computing or electronic device.

In various embodiments, computer system 600 may be a uniprocessor system including one processor 610, or a multiprocessor system including several processors 610 (e.g., two, four, eight, or another suitable number). Processors 610 may be any suitable processor capable of executing instructions. For example, in various embodiments processors 610 may be general-purpose or embedded processors implementing any of a variety of instruction set architectures (ISAs), such as the x96, PowerPC, SPARC, or MIPS ISAs, or any other suitable ISA. In multiprocessor systems, each of processors 610 may commonly, but not necessarily, implement the same ISA.

System memory 620 may be configured to store program instructions 622 and/or data 632 accessible by processor 610. In various embodiments, system memory 620 may be implemented using any suitable memory technology, such as static random access memory (SRAM), synchronous dynamic RAM (SDRAM), nonvolatile/Flash-type memory, persistent storage (magnetic or solid state), or any other type of memory. In the illustrated embodiment, program instructions and data implementing any of the elements of the embodiments described above may be stored within system memory 620. In other embodiments, program instructions and/or data may be received, sent or stored upon different types of computer-accessible media or on similar media separate from system memory 620 or computer system 600.

In one embodiment, I/O interface 630 may be configured to coordinate I/O traffic between processor 610 , system memory 620, and any peripheral devices in the device, including network interface 640 or other peripheral interfaces, such as input/output devices 650, In some embodiments, I/O interface 630 may perform any necessary protocol, timing or other data transformations to convert data signals from one components (e.g., system memory 620) into a format suitable for use by another component (e.g., processor 610). In some embodiments, I/O interface 630 may include support for devices attached through various types of peripheral buses, such as a variant of the Peripheral Component Interconnect (PCI) bus standard or the Universal Serial Bus (USB) standard, for example. In some embodiments, the function of I/O interface 630 may be split into two or more separate components, such as a north bridge and a south bridge, for example. Also, in some embodiments some or all of the functionality of I/O interface 630, such as an interface to system memory 620, may be incorporated directly into processor 610.

Network interface 640 may be configured to allow data to be exchanged between computer system 600 and other devices attached to a network (e.g., network 690), such as one or more external systems or between nodes of computer system 600. In various embodiments, network 690 may include one or more networks including but not limited to Local Area Networks (LANs) (e.g., an Ethernet or corporate network), Wide Area Networks (WANs) (e.g., the Internet), wireless data networks, some other electronic data network, or some combination thereof. In various embodiments, network interface 640 may support communication via wired or wireless general data networks, such as any suitable type of Ethernet network, for example; via telecommunications/telephony networks such as analog voice networks or digital fiber communications networks; via storage area networks such as Fibre Channel SANs, or via any other suitable type of network and/or protocol.

Input/output devices 650 may, in some embodiments, include one or more display terminals, keyboards, keypads, touch pads, scanning devices, voice or optical recognition devices, or any other devices suitable for entering or accessing data by one or more computer systems 600. Multiple input/output devices 650 may be present in computer system 600 or may be distributed on various nodes of computer system 600. In some embodiments, similar input/output devices may be separate from computer system 600 and may interact with one or more nodes of computer system 600 through a wired or wireless connection, such as over network interface 640.

In some embodiments, the illustrated computer system may implement any of the methods described above, such as the methods illustrated by the flowcharts of FIG. 2, FIG. 3, FIG. 4, and FIG. 5. In other embodiments, different elements and data may be included.

Those skilled in the art will appreciate that computer system s00 is merely illustrative and is not intended to limit the scope of embodiments. In particular, the computer system and devices may include any combination of hardware or software that can perform the indicated functions of various embodiments, including computers, network devices, Internet appliances, PDAs, wireless phones, pagers, etc. Computer system 600 may also be connected to other devices that are not illustrated, or instead may operate as a stand-alone system. In addition, the functionality provided by the illustrated components may in some embodiments be combined in fewer components or distributed in additional components. Similarly, in some embodiments, the functionality of some of the illustrated components may not be provided and/or other additional functionality may be available.

Those skilled in the art will also appreciate that, while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 600 may be transmitted to computer system 600 via transmission media or signals such as electrical, electromagnetic, or digital signals, conveyed via a communication medium such as a network and/or a wireless link. Various embodiments may further include receiving, sending or storing instructions and/or data implemented in accordance with the foregoing description upon a computer-accessible medium or via a communication medium. In general, a computer-accessible medium may include a storage medium or memory medium such as magnetic or optical media, e.g., disk or DVD/CD-ROM, volatile or non-volatile media such as RAM (e.g., SDRAM, DDR, RDRAM, SRAM, etc.), ROM, etc.

The methods described herein may be implemented in software, hardware, or a combination thereof, in different embodiments. In addition, the order of methods may be changed, and various elements may be added, reordered, combined, omitted, modified, etc. All examples described herein are presented in a non-limiting manner. Various modifications and changes may be made as would be obvious to a person skilled in the art having benefit of this disclosure. Realizations in accordance with embodiments have been described in the context of particular embodiments. These embodiments are meant to be illustrative and not limiting. Many variations, modifications, additions, and improvements are possible. Accordingly, plural instances may be provided for components described herein as a single instance. Boundaries between various components, operations and data stores are somewhat arbitrary, and particular operations are illustrated in the context of specific illustrative configurations. Other allocations of functionality are envisioned and may fall within the scope of claims that follow. Finally, structures and functionality presented as discrete components in the example configurations may be implemented as a combined structure or component. These and other variations, modifications, additions, and improvements may fall within the scope of embodiments as defined in the claims that follow.

While the foregoing is directed to embodiments of the present invention, other and further embodiments of the invention may be devised without departing from the basic scope thereof, and the scope thereof is determined by the claims that follow.

1. A computer implemented method for a recommendation engine utilizing progressive labeling and user context enrichment, comprising:
receiving a request from a current user of a user device, for a recommendation of an item, wherein the request comprises an image containing the item;
analyzing the item in the image using a plurality of objective machine learning models, wherein analyzing the item in the image comprises assigning an objective label and a percentage of confidence in the assigned label for each of the objective machine learning models;
analyzing the item in the image using a plurality of subjective machine learning models wherein analyzing the item in the image comprises assigning an subjective label and a percentage of confidence in the assigned label for each of the subjective machine learning models;
retrieving user context information for the current user;
generating a plurality of new labels based on the objecting labels, subjective labels, and user context information, wherein each of the plurality of new labels includes a weight signifying the importance of each new label;
receiving, from an image service, one or more recommendations, wherein the one or more recommendations comprise universal resource locations to clothing that matches the labels assigned to the image; and
transmitting the one or more recommendations to the user device when a confidence level in the recommendations exceeds a predefined threshold.

2. The method of claim 1, further comprising:
determining whether the image is valid; and
transmitting a message to a user device where the request was received when the image is determined to be not valid.

3. The method of claim 1, further comprising preprocessing the image, wherein pre-processing applies filters to the image including at least one of removing a background, removing faces, extracting items, enhancing the image, and normalizing the image.

4. The method of claim 1, further comprising:
analyzing cohorts, wherein analyzing cohorts identifies a second user who has similar purchasing preferences and purchasing history as the current user to determine which of the received one or more recommendations are a similar to the purchases of the second user; and
increasing a confidence level in one or more recommendations that are similar to the purchase history of the second user.

5. The method of claim 1, wherein the item in the image is one of an article of clothing, a piece of jewelry, a vacation home, or a piece of artwork.

6. The method of claim 1, wherein user context information comprises at least one of demographic information, user preferences, previously liked/click/purchased goods, influencer provided recommendations for the user, explicitly provided or inferred preferences, or behaviors based on cohorts.

7. The method of claim 1, wherein each of the plurality of objective machine learning models and each of the plurality of subjective machine learning models is retrained when a confidence level in the machine learning model drops below a predefined threshold.

8. A recommendation engine utilizing progressive labeling and user context enrichment, comprising:
a) at least one processor;
b) at least one input device; and
c) at least one storage device storing processor-executable instructions which, when executed by the at least one processor, perform a method including:
receiving a request from a current user of a user device, for a recommendation of an item, wherein the request comprises an image containing the item;
analyzing the item in the image using a plurality of objective machine learning models, wherein analyzing the item in the image comprises assigning an objective label and a percentage of confidence in the assigned label for each of the objective machine learning models;
analyzing the item in the image using a plurality of subjective machine learning models wherein analyzing the item in the image comprises assigning an subjective label and a percentage of confidence in the assigned label for each of the subjective machine learning models;
retrieving user context information for the current user;
generating a plurality of new labels based on the objecting labels, subjective labels, and user context information, wherein each of the plurality of new labels includes a weight signifying the importance of each new label;
receiving, from an image service, one or more recommendations, wherein the one or more recommendations comprise universal resource locations to clothing that matches the labels assigned to the image; and
transmitting the one or more recommendations to the user device when a confidence level in the recommendations exceeds a predefined threshold.

9. The recommendation engine of claim 8, further comprising:
determining whether the image is valid; and
transmitting a message to a user device where the request was received when the image is determined to be not valid.

10. The recommendation engine of claim 8, further comprising preprocessing the image, wherein pre-processing applies filters to the image including at least one of removing a background, removing faces, extracting items, enhancing the image, and normalizing the image.

11. The recommendation engine of claim 8, further comprising:
analyzing cohorts, wherein analyzing cohorts identifies a second user who has similar purchasing preferences and purchasing history as the current user to determine which of the received one or more recommendations are a similar to the purchases of the second user; and
increasing a confidence level in one or more recommendations that are similar to the purchase history of the second user.

12. The recommendation engine of claim 8, wherein the item in the image is one of an article of clothing, a piece of jewelry, a vacation home, or a piece of artwork.

13. The recommendation engine of claim 8, wherein user context information comprises at least one of demographic information, user preferences, previously liked/click/purchased goods, influencer provided recommendations for the user, explicitly provided or inferred preferences, or behaviors based on cohorts.

14. The recommendation engine of claim 8, wherein each of the plurality of objective machine learning models and each of the plurality of subjective machine learning models is retrained when a confidence level in the model drops below a predefined threshold.

15. A non-transitory computer readable medium for storing computer instructions that, when executed by at least one processor causes the at least one processor to perform a method for a recommendation engine utilizing progressive labeling and user context enrichment, comprising:
receiving a request from a current user of a user device, for a recommendation of an item, wherein the request comprises an image containing the item;
analyzing the item in the image using a plurality of objective machine learning models, wherein analyzing the item in the image comprises assigning an objective label and a percentage of confidence in the assigned label for each of the objective machine learning models;
analyzing the item in the image using a plurality of subjective machine learning models wherein analyzing the item in the image comprises assigning a subjective label and a percentage of confidence in the assigned label for each of the subjective machine learning models;
retrieving user context information for the current user;
generating a plurality of new labels based on the objecting labels, subjective labels, and user context information, wherein each of the plurality of new labels includes a weight signifying the importance of each new label;
receiving, from an image service, one or more recommendations, wherein the one or more recommendations comprise universal resource locations to clothing that matches the labels assigned to the image; and
transmitting the one or more recommendations to the user device when a confidence level in the recommendations exceeds a predefined threshold.

16. The non-transitory computer readable medium of claim 15, further comprising:
determining whether the image is valid; and
transmitting a message to a user device where the request was received when the image is determined to be not valid.

17. The non-transitory computer readable medium of claim 15, further comprising preprocessing the image, wherein pre-processing applies filters to the image including at least one of removing a background, removing faces, extracting items, enhancing the image, and normalizing the image.

18. The non-transitory computer readable medium of claim 15, further comprising:
analyzing cohorts, wherein analyzing cohorts identifies a second user who has similar purchasing preferences and purchasing history as the current user to determine which of the received one or more recommendations are a similar to the purchases of the second user; and
increasing a confidence level in one or more recommendations that are similar to the purchase history of the second user.

19. The non-transitory computer readable medium of claim 15, wherein item in the image is one of an article of clothing, a piece of jewelry, a vacation home, or a piece of artwork.

20. The non-transitory computer readable medium of claim 15, wherein user context information comprises at least one of demographic information, user preferences, previously liked/click/purchased goods, influencer provided recommendations for the user, explicitly provided or inferred preferences, or behaviors based on cohorts.
